(19) United States
(12) Patent Application Publication
(10) Pub. No.: US 2004/0185855 A1
(43) Pub. Date: Sep. 23, 2004

(54) Method and apparatus for continuing a call

(76) Inventors: Brian D. Storm, Round Lake Beach, IL (US); William R. Bayer, Wilmette, IL (US); Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/745,225

(22) Filed: Dec. 23, 2003

Related U.S. Application Data
(60) Provisional application No. 60/437,219, filed on Dec. 31, 2002.

(51) Int. Cl. H04Q 7/20

(52) U.S. Cl. 455/445; 455/450

(57) ABSTRACT

Disclosed is a method for transferring a connection with a base station (108) from one communication device to another communication device. After establishing a communication link (106) between the base station and a first communication device (100), a call is established over the communication link and then a first user module (102) is disengaged (104) from the first communication device. The call is then temporarily maintained (720) while the first user module is disengaged from the first communication device and finally the call is continued from a second communication device (120) after the first user module is engaged with the second communication device.

This application claims the benefit of the U.S. Provisional Application No. 60/437,219 filed on 31 Dec. 2002.

### FIELD OF THE INVENTION

The present invention pertains to communication systems, and more particularly to continuing a connection initiated with one communication device using another communication device.

### BACKGROUND OF THE INVENTION

It is becoming more common for individuals to own and operate a multitude of electronic devices, such as a cellular radiotelephone, a wireless communication system integrated in a vehicle, a personal computer, a personal digital assistant (PDA), or a pager, just to name a few examples. The desire to communicate voice, video and or data, may require that individual users use more than one communication device for a single communication to obtain optimum performance for a particular environment or event. As the user acquires more electronic devices, each of which has their own primary defining characteristic, such as keyboard type, display size, and portability, the user will be required to switch from one device to another depending on the user's needs or circumstances at any given time. Although multiple devices exist, it is difficult for a user to transfer a communication connection, such as an active completed telephone connection (also known as an active telephone call) or an Internet connection, from one device to another device without disconnecting.

One known device permitting portable transfer of a subscriber identity amongst cellular radiotelephones is a subscriber identify module (SIM), such as those employed in the Global System for Mobile communications (GSM). A SIM stores user data, including the user's mobile identity number (MIN). The SIM is installed in a mobile station in order to enable connection via a receiving base station and a mobile switching center. Additionally, the module can be readily removed from one device and transferred to another device. However, removal of the SIM from a device engaged in an established call will result in termination of the established call. In most cases the device must be powered down before the SIM can be removed.

It is also known to provide a modular device that allows an incoming wireless alert message to be received by a first modular element while disengaged from a second modular element. However, to complete a bi-directional connection, the module elements must be connected.

Accordingly it is desired to enable a user to move a call from one device to another device without dropping the call.

### BRIEF DESCRIPTION OF THE DRAWINGS

The accompanying figures, where like reference numerals refer to identical or functionally similar elements throughout the separate views, serve to illustrate various embodiments and to explain various principles and advantages of the present invention.

FIG. 1 is a block diagram illustrating a communication system in which the invention may be employed.

FIG. 2 is a circuit schematic in block diagram form illustrating a subscriber device.

FIG. 3 is a circuit schematic in block diagram form illustrating an alternate embodiment of a user module.

FIG. 4 is a circuit schematic in block diagram form illustrating another alternate embodiment of a user module.

FIG. 5 is a flow chart illustrating operation of a communication device or user module.

FIG. 6 is a flow chart illustrating operation of a network.

FIG. 7 is a flow chart illustrating an alternate operation of a communication device or user module.

FIG. 8 is a flow chart illustrating an alternate operation of a communication device or user module.

FIG. 9 is a flow chart illustrating an alternate operation of a base station.

FIG. 10 is a flow chart illustrating another alternate operation of a communication device or user module initiating a call move.

FIG. 11 is a flow chart illustrating another alternate operation of a communication device or user module receiving a moved call.

FIG. 12 is a flow chart illustrating another alternate operation of a user module.

FIG. 13 is a flow chart further illustrating the alternate operation of a communication device or user module of FIG. 12.

FIG. 14 illustrates a first environment.

FIG. 15 illustrates a second environment.

### DETAILED DESCRIPTION OF THE INVENTION

As wireless communication devices have become more common in every day life, users tend to have multiple environments where different equipment is available, and to carry portable devices into multiple environments. Different devices have different capabilities, and offer different features and advantages. Some devices only operate in certain environments, such as with a local area network, or are stationary, such as desktop computers. Additionally, while devices such as cellular radiotelephones and personal digital assistants (PDAs) offer great portability, they do not have displays and keyboards of the type offered with computers.

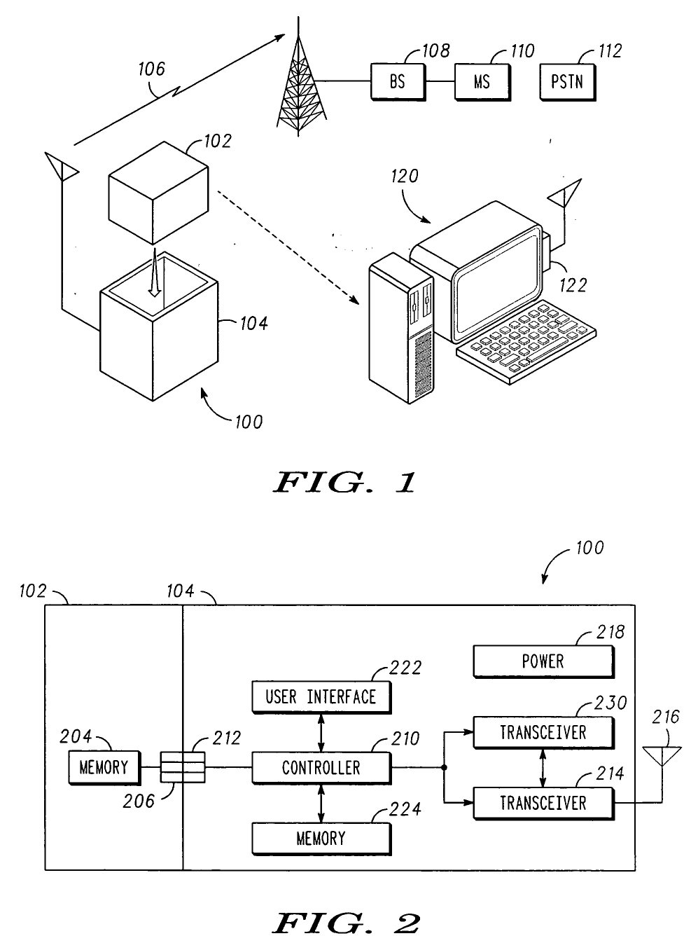

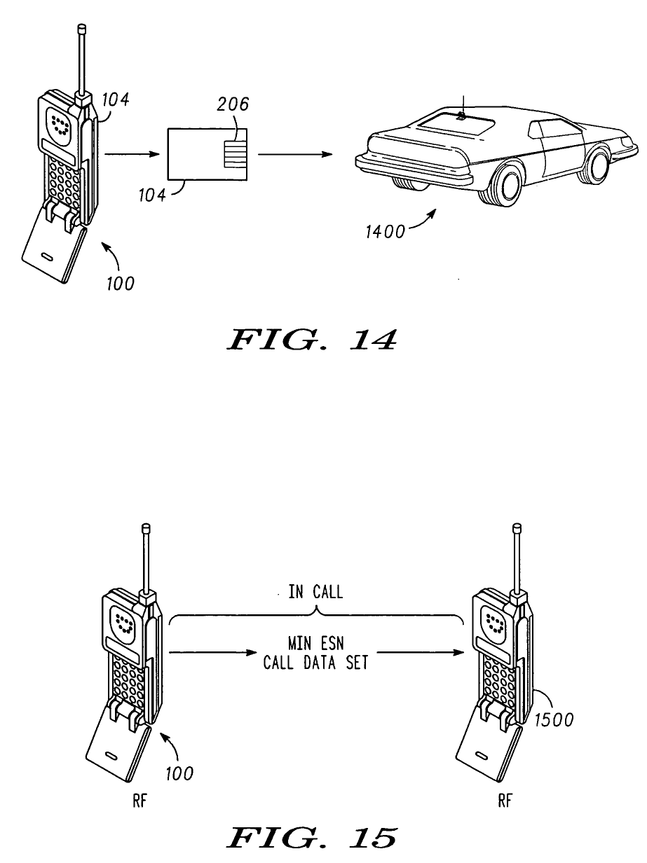

For a variety of reasons, it is envisioned that users will want to readily move an established connection from one device to another device without interruption and with minimal user manipulation. One exemplary use is a call initiated on cellular radiotelephone integrated in a vehicle 1400 (FIG. 14). When the user reaches a final destination, they want to leave the car but continue the call. If the user has a portable wireless communication device 100, such as a cellular radiotelephone, it is desirable to continue the call on this device. Another use is moving a call between two devices 100 (FIG. 1) having different capabilities, such as a cellular radiotelephone 100 and a personal computer (PC) 120. For example, a user engaged in a voice call over a cellular radiotelephone may determine that they want to display data from the call, or switch to a data portion, while maintaining the currently established call. The user would like to maintain the link already established and transfer to the device that has greater capability to carry out a data communication.

In order to maintain a link, some wireless devices require a continuous connection, or a periodic intermittent connection such that it is nearly continuous, when in use. Other devices maintain a connection only when in use. The link may be constant as with analog systems, or virtual as in computer or digital cellular networks wherein data is transmitted periodically to maintain the “connection” also known as a “logical link.”

In operation, a continuous link for a wireless connection is established by a first communication device 100 (FIG. 1). The call is moved to a second communication device 120 using a portable module (102). A connection is first established while a first module is coupled or engaged to a second module. During the call, or at least when a connection or link is established, the first module is removed from the second module. The connection is maintained by the first module while the first module is decoupled or disengaged from the second module. Data or voice information being transferred may either be suspended or stored, in the base or the first module, during the disengagement. The period of maintenance of the link will vary depending on the nature of the connection, the time, as well as other parameters settable in the device or system. Once the first module is coupled with a third module or potentially back with the second module, the call is continued or resumed. This process may or may not be directly initiated by the user.

A wireless communication device 100 (FIG. 1), has a first module 102 and a second module 104. The wireless communication device supports a wireless communication link with another device, a base station, a satellite, or the like. The wireless communication device 100, can be a mobile station, radio equipment, or a mobile unit, and may for example be a cellular radiotelephone, a telematics in-vehicle system, or a personal computer, pager, personal digital assistant, or handheld computer including an internal or coupled wireless communication circuitry. The communication circuitry may include one or more of a transmitter, a receiver and a transceiver.

A first module 102, which may for example be a user module, comprises a memory 202 (FIG. 2) and a connector 206, and is operable to store a call state data set. The memory 204 may be implemented using any suitable known memory, such as a random access memory, a read only memory, erasable programmable read only memory, electronically erasable programmable read only memory or the like. The connector will be described in greater detail herein below. The first module may be implemented in a Subscriber Identity Module (SIM), a smart card, a proximity card, or a memory element storing a software program or data. The connector 206, which is described in greater detail herein below, may be an electrical connector, a mechanical connector, or both an electrical and mechanical connector.

The illustrated second module (FIG. 2) comprises a controller 210, a connector 212, a transceiver 214, an antenna 216, and a power source 218 for supporting communications over link 106. The second module may optionally contain a user interface 222 for controlling the operation of the mobile and a secondary transceiver 230 supporting short range connections of the type known in the art, such as infrared, radio frequency, or the like. The connector 212 will be described in greater detail herein below. The controller 210 may be implemented by one or more digital signal processors., microprocessor, microcontroller, programmable logic, or the like. Optionally the second module may comprise a separate memory 224, in addition to any memory integrated in controller 210. The controller 210 uses memory 224 to execute the steps necessary to generate the protocol and to perform other functions for the wireless communication device, such as writing to a display or user interface 222, accepting information from a user interface 222, or controlling the transceivers 214 and 230. The second module 104 may also include an ASIC (not shown) to process signals to and from an audio circuitry (not shown) in the user interface, such as a microphone and a speaker.

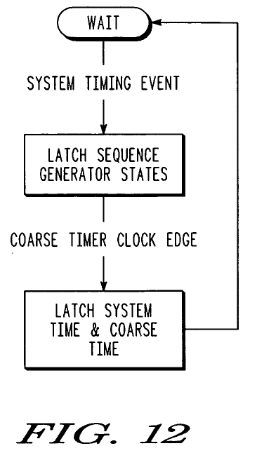

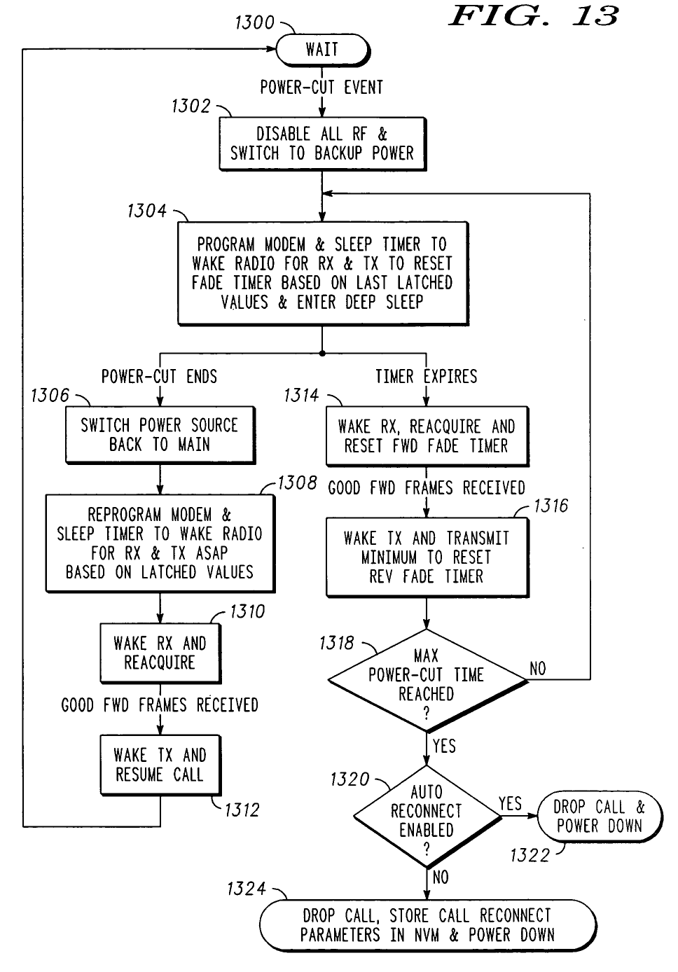

The second module 104 can be any one of many different types of devices. It is envisioned that these device will have many capabilities, functions, locations, and/or sizes. For example the second module 104 may be a cellular radiotelephone having a standard user interface such as a keypad, display, microphone, and a speaker (all not shown). The second module 104 may alternately have a large color touch screen display, stereo sound capability, HDTV capability. Alternatively, the second module 104 may be a Telematics unit installed in an automobile. The first module 102 can engage the second module 104 when it is plugged into the second module, such as when the second module is a receiving station in an automobile, or the first and second module may be connected through a wireless link when the two modules come in close logical proximity. In yet another exemplary embodiment, the second module may be a personal computer (PC), personal digital assistant (PDA), or a home appliance such as a washing machine, refrigerator or the like. In FIG. 1, the second module, or second device, 120 is illustrated to be a PC having a cellular modem 122 coupled thereto to enable data and/or voice communications to be established with base station 108. As described with reference to FIGS. 12 and 13, the second module 104 may comprise a user interface, a power source and optional user applications, such that the first module comprises the primary transceiver circuitry and the call data set, and the second module comprises the primary battery supply and user applications (such as games, internet browsers, personal productivity tools, or the like).

As indicated briefly above, the first module includes a connector 206 and the second module includes a connector 212. The connectors 206 and 212 enable the first module 102 and the second module 104 to establish a mechanical and/or a communication intercoupling. The first module 102 may plug directly into the second module 104 as illustrated in FIG. 1. Alternatively, a cable (not shown) may be utilized to connect the two modules. The connectors 206, 212 can physically connect the first module 102 to the second module 104. For example, the connectors 206 and 212 may comprise male and female connectors that enable quick disconnect mating engagement of the first module and the second module. Alternatively, the first module 102 and the second module 104 may communicate through a wireless coupling, such as a light or radio frequency signal link. In the case of a wireless link, the two modules can be coupled when in close proximity to one another. Close proximity means within the range of a Bluetooth™ connection, an infrared connection, i.e. IrDa, Wi-FI, 802.11, or a similar short-range wireless connection. It is envisioned that for security reasons, a mechanical connection of the modules will be preferred even where a wireless connection is utilized. Those skilled in the art will recognize that a wireless coupling can be employed where the first module 102 is mechanically received in the communication device 104.

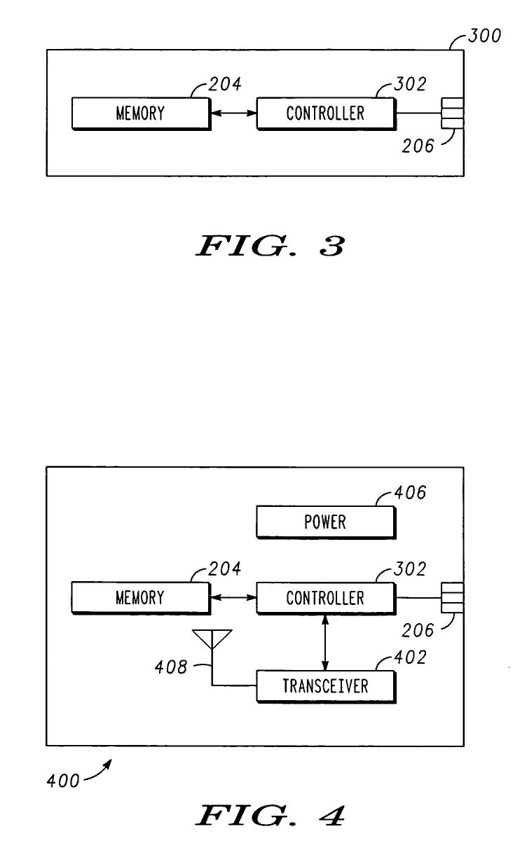

User module 300 (FIG. 3) is an alternate embodiment of the user module 102. The user module 300 includes a controller 302. The controller 302 can be implemented using any suitable circuitry, such as one or more of a microprocessor, micro-controller, digital signal processor, programmable logic or the like. The controller provides security and control for the module, and may be implemented using smart card or SIM technology. The controller may be powered from an internal power source (not shown) or from the module 104 via connector 206.

A user module 400 (FIG. 4) according to yet another alternate embodiment includes a transceiver 402 and a power source 406. The transceiver 402 may be implemented using any suitable communication device, such as one or more of a transmitter, receiver and transceiver. The transceiver is controlled to communicate with module 104, base station 108, communication device 120, or other communication devices (not shown) using conventional wireless or wired communication protocols.

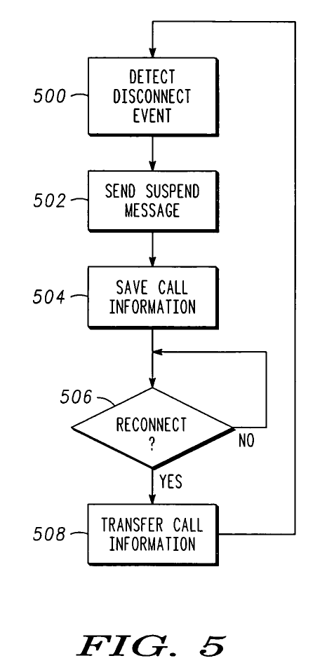

The operation will now be described with respect to FIG. 5. The communication device 100 detects a disconnect event in step 500. The disconnect event may be detected by controller 210 (FIG. 2) or controller 302 (FIG. 3). The disconnect event may be triggered by operation of a disconnect key (not shown) on module 102, 104, 120, or a lever such as an eject mechanism (not shown) in communication device module 104, 120 to which module 102 is engaged. In response to the disconnect event being detected, a suspend message is transmitted through transceiver 214 to base 108, as indicated in step 502. The call information, referred to herein as the call state data set, is stored in memory 204 as indicated in step 504. When module 102 is reconnected, as indicated in step 506, the call information, or data set, is transferred to the newly connected communication device 104, 120.

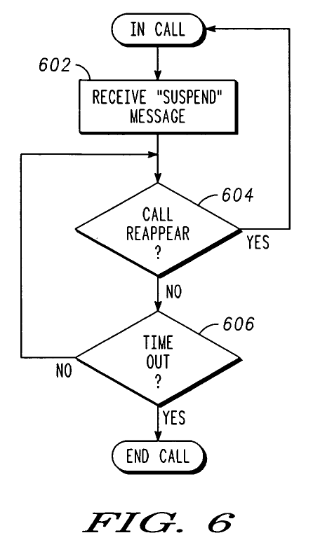

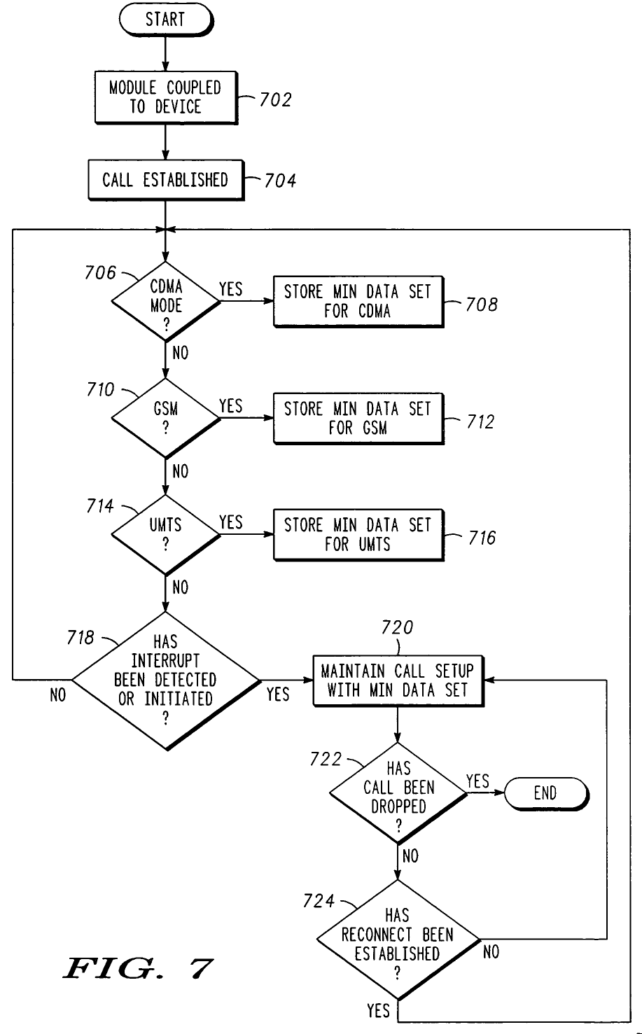

An optional network operation complementary to the mobile station operation of chart FIG. 5 will be described with respect to FIG. 6. In step 602, the network detects a “suspend” message from the mobile station 100. The network, responds to the suspend message to set a timer, for example. The network 108, 110 waits for the call to reappear, step 604, at which time the call is removed from the suspended state. If the timer times out before the call reappears, as determined at step 606, the call is terminated.

Alternatively, as described in greater detail herein below, the network may employ a call drop and/or fade timer which maintains the call for a predetermined time, and operates without any pre-notification of the detachment event.

An alternate operation of the device 100 is described with respect to FIG. 7. When a user module 102, 300, 400 is connected to a communication device 104, as indicated in step 702, and a call is established as indicated in step 704, the minimum data set is stored in memory 204. For a communication device 100 capable of operating over more than one system, referred to herein as a multimode communication device, the controller 210 and/or 302 determines in which mode the coupled communication device is operating. For example, if it is determined that the communication device 100 is operating in CDMA mode in step 706, the minimum data set associated with the CDMA system is stored in memory 204, as indicated in step 708. If it is determined that the communication device 100 is operating in GSM mode in step 710, the minimum data set associated with the GSM system is stored in memory 204, as indicated in step 712. If it is determined that the communication device 100 is operating in W-CDMA (so-called 3-G) mode in step 714, the minimum data set associated with the W-CDMA system is stored in memory 204, as indicated in step 716. Those skilled in the art will recognize that the decision block 706, 710 and 714 will not be necessary where the device operates in a single mode. It will also be recognized that more than 3 decision blocks, can be provided according to the number of operating systems over which the communication device 104 can operate.

When an interrupt event is detected in step 718, such as removal of the module 102 or a detachment trigger, the call setup is maintained in the communication device 100 as indicated in step 720. The controller 210 monitors the call in step 722 to determine if it has been dropped or a reconnect has occurred, as determined in step 724. A reconnect can be determined from any suitable means, such as timing out of a timer, communication of a message from the communication module 406 indicating that a new connection has been established, or a communication of a predetermined message from the base station 108 (it is envisioned that an overhead message could be provided indicating that a reconnection has been made and the device 104 to which the module is no longer connected should drop the connection).

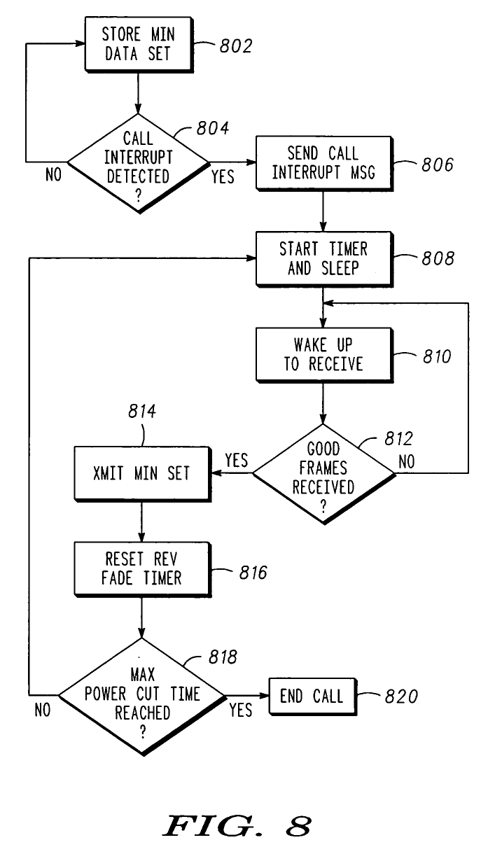

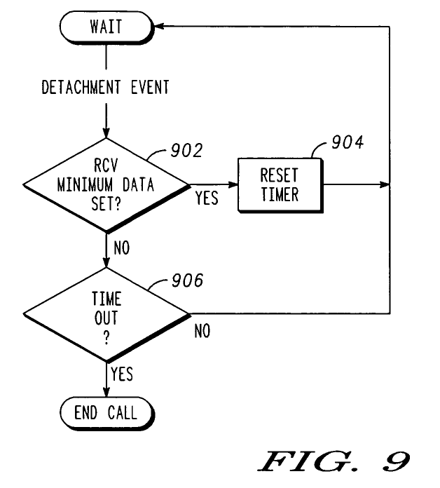

Yet another alternate operation will be described with respect to FIG. 8. During the disengagement, the first module 102 maintains link 106 in accordance with the communication system mode of operation and the corresponding minimum data set 708, 712, 716 (FIG. 7). In the exemplary situation in which the mobile station 100 is in CDMA mode, this is accomplished by ensuring that fade timers do not lapse. In general, the lapse of a fade timer, by not affirmatively being reset, will lead to the call or specific link 106 being disassembled, i.e. the call being dropped. In order to maintain the link 106, the fade timers must be reset prior to lapsing of the requisite time. The fade timers consist of a forward link fade timer and a reverse link fade timer. The forward link fade timer is resident at a mobile station 100.

FIG. 8 shows a flow diagram that illustrates the process using fade timers. As noted earlier, the mobile station 100 stores the minimum data set 706 in step 802. When the interrupt is detected in step 804, a call interrupt message is transmitted and a timer is started in step 808. Alternatively, a previously engaged timer is transferred with and monitored by the first module 102. The first module 102 preferably enters sleep mode to conserve power, but this is not necessary. When in sleep mode, the first module 102 will have to wake up to turn on the receiver to reacquire the expected transmission from the base station 108 as indicated in step 810. The first module 102 will adjusts the timing if necessary during step 810. When synchronization is verified, the first module 102 monitors predetermined known transmissions from the communication system and determines if the transmission frames received are good frames of data in step 812. If the frames of data are good, the minimum data set required to maintain the call is transmitted in step 814, the forward link fade timer is reset in step 816. This is done at a predetermined time or interval in accordance with the timer in the first module 102. This allows the first module 102 to sleep i.e. enter power reduced mode, to conserve power. Specifically, at the appropriate time, the first module 102 will wake up and reacquire timing. To reacquire timing the first module 102 must search to get fine timing i.e. using the pilot to reestablish chip timing, however the long code short code is not reacquired as this is saved in the memory of the first module 102. Once the timing is affirmatively established, good frames have been received, the first module 102, in response thereto resets the forward fade timer. This process will continue until it is determined that maximum power cut time is reached, as determined in step 818. If the maximum allowed time is reached, the call is dropped, as indicated in step 820.

Continuing with FIG. 9, base station operation complementary to the operation described with respect to FIG. 8 will be described. A reverse fade timer (not shown) is present at the base station 108 of the communication network. At a predetermined time maintained at the first module 102, the first module 102 will transmit the minimum predetermined transmission data set 708 to the base station 108. The base station 108 checks for reception of the minimum data set, as indicated in step 902. At the base station 108, upon receipt of the minimum predetermined data set 708 from the mobile station 100, resets the reverse link fade timer as indicated in step 904. In the exemplary CDMA system, assuming that the first module 102 has maintained or adjusted synchronization, the first module will periodically wake to transmit a portion of minimum data set 708 to the base station in order to reset the reverse fade timer. The portion of the minimum data set 708 comprises enough data that allows the base station 108 to determine whether the data received is good valid data. In general, the base station 108 will need to receive two good frames of data that will allow a cyclic redundancy test (CRC) to validate the data. Those skilled in the art will recognize that other known techniques can be used to validate the data. If the first data set is not received prior to the timer expiring, as determined in step 906, the active connection, or call, is terminated.

In order to transmit, the first module 102 (FIG. 1) operating on the exemplary CDMA system, will need to retain the ESN and MIN as discussed previously in describing the transmission of data on the reverse link. Again the first module 102, as in normal operation, will use the ESN and the MIN to code the information transmitted to the base station. The first module 102 will further need to have access to the traffic channel information, the long code and the short code information used during establishment of the call 304.

Resetting these fade timers is necessary to maintain the link 106 between the mobile station 100 and the base station 108. In an exemplary embodiment, it may be necessary to only reset the reverse link fade timer that is resident at the base station 108. In this case the first module 102, knowing that it is in a temporary suspend mode by recognizing that it has been detached from a second module 104, may suspend its forward fade timer until reconnected. In this case the first module 102 would still be required to reset the reverse link fade timer by continuing to transmit to the base station 100 good frames of data at predetermined times as discussed above.

Other information that is not necessary to maintain the link 106 need not be communicated during the detachment of the first module 102, and the module 104 has the capability to only maintain the link 106 in this fashion. Resetting of the fade timers continues until the first module is engaged with another module, the call is terminated by a time out, or the link 106 disassembled.

Those skilled in the art will recognize that according to an alternate embodiment of the invention, the reverse fade timer may be reset exclusively, while the forward link fade timer is suspended.

While the first module 102 is decoupled or disengaged from a second module 104 or third module 108, the first module 102 actively resets the forward and reverse fade timers. This keeps the link 106 which was established in the link establishment process active and the channel is not released for use by other mobile stations (not shown). In the exemplary CDMA communication system, a pseudo noise (PN) code, and more particularly Walsh functions for spreading the code on each channel are used to define a channel. A predetermined Walsh code is assigned for communication between the mobile station 100 and the communication system 110 each time a link 106 is established. When the first module is disengaged from the second or third module 104, 108, the connection is maintained over the same channel that was established when the call was made when the first module 102 and the second module 104 were engaged.

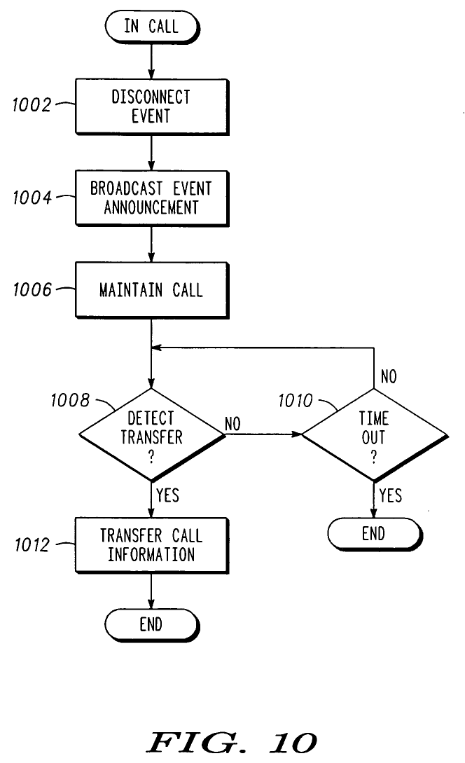

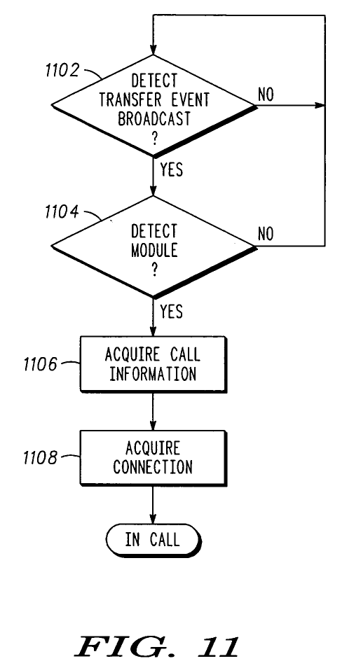

Yet another alternate operation will be described with respect to FIGS. 10 and 11. A subscriber device 100 detects a detachment event in step 1002. In response to the detachment, an event announcement is broadcast in step 1004. The broadcast may be made via transceiver 214 or 230 (FIG. 2). The call is maintained by module 104 as indicated in step 1006. If another device 120 responds by indicating a transfer, as determined at step 1008, the call information is transmitted to the other device. If the timer times out, as determined at step 1010 prior to the call transferring the call is terminated.

The other device 120 (FIG. 1) detects a call transfer event broadcast, as indicated in step 1102 (FIG. 11). Device 120 waits for attachment of a module associated with the call of the transfer event broadcast, as indicated in step 1104. If the module 102 is attached, the call information is received as indicated in step 1106. The call is then acquired by the other device, as indicated in step 1108.

In operation, with the first module 102 and the second module 104 engaged, a communication link 106 is established between mobile station 100 and base station 108 to initiate a call. The base station connects to a mobile switching center 110, which connects to another base station (not shown), another mobile switching center (not shown) or a conventional land-line telephone network (labeled PSTN) 112. The engagement of the two modules creates a complete mobile station 100. A complete mobile station being a wireless communication device that has all the components necessary to establish or initiate and then maintain a connection and a call, i.e. the transfer of voice and/or data over a wide area wireless link 106.

Once the first module 102 and the second module 104 are engaged, a connection or link 106 can be established utilizing the link 106. The method for establishing and maintaining the connection will depend on the system or systems that the device may operate on. Some devices are multimode capable devices and can operate on a plurality of different communication systems. The service provider and the type of multiplexing technique used in a given system generally differentiate the different systems from one another. Some exemplary systems include code division multiple access (CDMA), time division multiple access (TDMA), global system for mobile communication (GSM), UMTS, wideband CDMA (WCDMA), local area networks such as the Institute for Electrical and Electronics Engineers (IEEE) specification 802.11, and so called WiFi and Telematics systems. These are exemplary systems only and the present invention may incorporate any wireless communication system for establishing the link, including one or a plurality of these multiple access techniques in combination.

In one exemplary embodiment, the system may be a CDMA communication system. To establish a link 106 in the CDMA system, the mobile station 100 (i.e. the first module 102 engaged to the second module 104) first scans a set of predetermined frequencies. Once the known predetermined frequency channels have been found, the mobile station 100 will scan a predetermined set of code or logical channels that fall under the primary or secondary carrier channel number. The predetermined set of logical channels includes at least one pilot channel. The mobile station 100 will use a known Walsh code for the pilot channel search for the pilot channel using the same Walsh code. The mobile station 100 will generally acquire the pilot channel within a given time frame. Once the pilot channel is acquired the mobile station will acquire the synchronization channel, and therefrom acquire information regarding the system configuration and timing are obtained regarding the system. The mobile station 100 then monitors the paging channel in anticipation of an incoming call or the user may also make a call at this point. The call can be voice or data.

When the mobile station transmits to the base station 110 (i.e. the reverse link) over a traffic channel, the mobile station 100 codes its communication in several fashions. One operation of the coding utilizes the electronic serial number (ESN) and the mobile identification number (MIN) to code the transmission on the reverse link. This coding is done with every transmission on the reverse link. In the exemplary embodiment, the ESN and the MIN are used in conjunction with a Hashing function, the PN long code mask and the desired code to be transmitted (either voice or data). Because the base station 110 is linked and synchronized with the mobile station 100 and has the ESN and MIN of the mobile station 100, the base station 110 can decode the message from the mobile station 100. The synchronization is important to maintain the link 106 between the mobile station 100 and the base station 110 to ensure the long code mask of both station is synchronized. The synchronization is derived from the base station 110 and the mobile station 100 adjusts its internal timing to match that of the base station 110. In the exemplary CDMA system, the timing is very important for if the synchronization is off by one bit of data, the information will not be decoded properly. Therefore, synchronization is constantly checked and the timing adjusted if necessary.

The operation of another exemplary embodiment of the invention will now be described with respect to FIGS. 12 and 13. The embodiment will again be described with respect to a CDMA radiotelephone, but those skilled in the art will recognize that the invention will be applied to other systems, such as GSM and WCDMA. The embodiment of FIG. 4 may have a very limited power source. The following description describes a method to keep a phone call up during an extended time when it has a very limited power source. Initially it is noted that the device advantageously provides a low power technique to implement flywheel timing and to satisfy the fade timers for both the forward and reverse links. This can be achieved even for a CDMA modem where timing is extremely critical in rapidly reacquiring the system by following the following two flow charts.

FIG. 12 shows the basic functions that have to take place regularly in order to facilitate an unannounced swap. At a predetermined meaningful system event, such as a frame boundary, a slot boundary, PN rollover, and the like, the states of the linear sequence generators are stored in 1202. The system time of this event is assumed to be known, but if not it can be stored at this step as well. In order to reference this event to the clock that will be doing the timing during the actual swap, the system time is latched on that clock edge along with the value of the coarse clock counter in step 1204. All of this together provides precise timing between the meaningful system event and the coarse clock and will be used to project when to wake-up the module in the future to reacquire. It will also indicate how much to advance the linear sequence states stored earlier.

FIG. 13 further describes the operation of the module 400 of FIG. 4 where the transceiver 402 is the primary transceiver in communication with base 108, and the module 104 merely provides primary power, and optionally a user interface and software applications. Most of the time, the module is operating normally and waiting for a power-cut event as indicated in step 1300. Detachment of module 102 from module 104 is an example of a power cut event. Once the power cut is detected, the power consumed by the module 400 is reduced to a minimum and the controller 302 sets up for deep sleep mode powered by source 406, as indicated in steps 1302 and 1304. If the swap goes quickly, there is no need to do anything out of the ordinary to reset the fade timers and the call can resume in a straightforward manner.

If the power cut ends, the power source is switched from source 406 to the device source (e.g., 208 of module 104) as indicated in step 1306. The module controller 302 reprograms the modem and sleep timers, wakes up the device transmitter and receiver (transceiver 402) as quickly as possible, based upon the values stored in the module, as indicated in step 1308. The device 102 will then wake up the receiver in step 1310 to reacquire, and wake up the transmitter in step 1312 to resume the call.

However, if the swap takes additional time, the fade timers could expire and the base could tear down the call. To avert this, the mobile will periodically transmit 1 or 2 good frames at predetermined intervals, such as every 5 seconds, and then return back to deep sleep. This internal wake-up timer will be preset in step 1304. When the wake-up timer expires, the receiver is woken up and the forward timer is reacquired and reset in step 1314. In step 1316, the transmitter is woken, and minimum data set required to reset the reverse fade timer is transmitted.

If the module controller 302 continues to cycle through steps 1304, 1314, 1316 and 1318, the hot swap is taking longer than expected and any attempt to keep the call up should be abandoned. This is accomplished using a maximum power cut duration timer which is set 1302 and monitored in step 1318. When the monitor expires, the call is abandoned in one of two ways. The user has the option of powering down, as indicated in step 1322, or an auto-reconnect feature in step 1324. The auto connect feature 1324 stores critical call parameters in non-volatile memory prior to powering down and when external power is restored, attempts to reconnect. This feature is selected by user action through a menu system, for example.

The above description gives CDMA examples. However, the invention is equally applicable to any system. For example, where the communication system type is a GSM system, the radio link failure criterion utilizes a radio link counter in a similar fashion to the fade timer used in CDMA. GSM also employs a forward link and a reverse link. The purpose of monitoring radio link failures in the GSM mode of the Mobile station 100 is to ensure that calls with unacceptable voice/data quality, which cannot be improved either by RF power control or handover, are either re-established or released. In this exemplary embodiment the radio link counter will be used to maintain the link during the suspended call while the user is transferring the first module 102 from one device to another. The radio link failure criterion is based on the radio link counter “S.” If the MS 100 is unable to decode a Slow Associated Control Channel (SACCH) message, S is decreased by 1. In the case of a successful reception of a SACCH message S is increased by 2. In any case S shall not exceed the value of RADIO_LINK_TIMEOUT. If S reaches 0 a radio link failure shall be declared. The action to be taken is specified in 3GPP TS 04.18. The RADIO_LINK_TIMEOUT parameter is transmitted by each BSS in the BCCH data (see table 1). The MS 100 or first module 102 shall continue transmitting as normal on the uplink until S reaches 0. The algorithm shall start after the assignment of a dedicated channel and S shall be initialized to RADIO_LINK_TIMEOUT. The mobile station shall continue transmitting the minimum data set as long as it receives information of the SACCH.

An MS 100 listening to a voice group call or a voice broadcast, upon a downlink radio link failure shall return to idle mode and perform cell re-selection.

The criteria for determining radio link failure in the BS 110 is based upon either the error rate on the uplink SACCH(s) or on received signal level (RXLEV) or receive signal quality (RXQUAL) measurements of the MS 100. The exact criteria to be employed shall be determined by the network operator. For channels used for a voice group call, the radio link failure procedures in the BS 110 shall be reset upon the re-allocation of the uplink to another MS. Upon an uplink radio failure, the network shall mark it as free. Therefore it is important for the MS 100 to continue transmissions to the BS 110 to ensure that the BS 110 does not determine that a radio link failure has occurred. This is accomplished by either transmitting on the uplink SACCH(s) or simply based upon RXLEV or RXQUAL.

In summary, for the exemplary CDMA system the minimum data set will include the ESN, MIN, the frequency, the PN offset, and the Walsh code for traffic channel. In general though, the mobile station 100 will store the particular minimum data set required by the respective communication systems supported by the type and capability of the mobile station has. The rate of storage will be at a frequency that is appropriate for the corresponding system and optimized such that memory and power consumption or conserved.

The mobile station 100 monitors for the detection of an attachment and detachment events. These events, or interruptions, may be detected merely by disengagement of the first module 102 from the second module 104, or an actuated switch initiated by the user to disengage the first module 102 and the second module 104, or a signal from the communication system over the wireless link 106. If the detection of the interrupt is not processed by simply disengaging or decoupling the first and the second module 102, 104, the user will have to initiate by selecting a disengagement function from a button or option in the software of the mobile station 100. The eject button will start the process such that the user can disengage the two modules in an orderly fashion. The interrupt may also come from the communication system over the wireless link 106, via an interrupt command. In this case the mobile station will receive an interrupt and maintain command, and this will initiate the process in the mobile station 100. In either case, the mobile station 100 will alert the user that it is now ok to disengage the first and second modules 102, 104.

In the case where the user initiates the interrupt by disengaging the first module 102 from the second module 104, the base station 110 may not even know that the two modules have been separated. As long as the base station 110 continues to receive transmission from the first module 102 to reset the reverse link fade time, the base station 110 will not drop the call.

In this case the first module 102 must have the capability to receive and transmit when the first module 102 is disengaged from any other module. A power source 406 (FIG. 4) is therefore coupled to or integrated within the first module 400. This allows a timer within the first module 102 to determine when to receive information in order to reset the forward link fade timer and when to transmit to the base station 110 in order to reset the reverse link fade timer. The first module 102 must also be able to determine that the communication received is the correct communication and then prepare the proper data from the minimum data set to be transmitted to the base station 110.

In case where the first module 102, 300 has a memory, such as memory 204, but does not have a power source, the minimum data set 708, 712, 716 is stored in memory 204. However, the first module does not receive or transmit during the disengagement period. In this case the mobile unit 100, prior to disengagement of the first module 102 from the second module 104, can send a suspend command to the base station 108. The suspend command notifies the base station 108 that a mobile station including the first module 102 will be back and that the base station 108 should keep the already established link 106 in place. Because the first module 102 has the minimum data set, the first module when subsequently attached, or engaged, with either the second module 104 or a third module 120 will connect on the same channel that was used for the existing call already established prior to detachment of the first module. The information of the minimum data set retained with the memory 204 of the first module 102 is enough to allow the mobile station 100 to maintain the same connection with the base station 108 following detachment.

It is envisioned that the first module 102 may store the user MIN and ESN. The user can initiate the desired suspend command while the call is transferred from one module or device to another module or device.

Those skilled in the art will recognize that the minimum data set required by the base station may not be the same data as the call state data set in module 102. The foregoing description is not intended to be exhaustive or to limit the invention to the precise form disclosed. Those skilled in the art will recognize that modifications or variations are possible in light of the above teachings, and all modifications and variations shall be deemed to be within the scope of the invention which is limited only by the claims.

1. A method for transferring a connection with a base station from one communication device to another communication device comprising the steps of:
establishing a communication link between a base station and a first communication device;
establishing a call over said communication link;
disengaging a first user module from said first communication device; and
temporarily maintaining said call while said first user module is disengaged from said first communication device; and
continuing said call from a second communication device after the first user module is engaged with the second communication device.

2. The method of claim 1, wherein the first user module stores a call state data set and said first communication device periodically transmits a minimum data set at least while said call is temporarily maintained.

3. The method of claim 2, wherein said step of continuing includes continuing said call through said second communication device over the same communication channel used in said step of establishing a call.

4. The method of claim 3, wherein said communication channel being defined by a pseudorandom noise code.

5. The method of claim 3, wherein said communication channel is a GSM channel.

6. The method of claim 1, where said step of maintaining said communication link includes transmitting a minimum data set necessary to maintain the connection.

7. The method of claim 6, wherein said minimum data set includes traffic channel parameters.

8. The method of claim 6, maintaining said communication link between said first user module and said base station by transmitting a data set including a hashing function, a mobile identification number (MIN), an electronic serial number (ESN), and a PN long code mask.

9. The method of claim 8, wherein said data set further comprises a PN long code, PN short code, an a RF channel.

10. The method of claim 6, maintaining said communication link while said first user module is disengaged by transmitting a reverse link fade timer reset message to maintain a connection until the first user module is engaged with another module.

11. The method of claim 6, wherein said minimum data set is a mobile identification number (MIN), an electronic serial number (ESN), and RF channel number.

12. The method of claim 11, wherein said minimum data set further comprises a Walsh code.

13. The method of claim 6, wherein a minimum data set is transmitted from said first user module to a third module when said first user module is decoupled from said first communication device.

14. The method of claim 1, comprising:
after said step of establishing a connection while a first module is coupled to a second module,
storing a minimum data set corresponding to a communication mode in a memory on said first module;
determining that a call has been suspended; receiving good frames at said first module;
transmitting data in accordance with at least a portion of said minimum data set to a base station transmitting said good frames; and
resetting a timer such that said connection is maintained with said first module.

15. A method in a wireless communication device for maintaining a call while transferring the call from one device to another device comprising:
coupling a module to a first device;
establishing a call through said first device;
decoupling said module from said first device; and
maintaining said call.

16. The method as defined in claim 15, further including the step transmitting to a second device said data set pertinent to said communication mode of operation by SIM or wireless link.

17. The method as defined in claim 15, further including the step of coupling said module to a second communication device, then transmitting or accessing data to or by said third device.

18. The method as defined in claim 17, continuing said call when said first device is coupled to said second device.

19. The method as defined in claim 15, wherein the decoupling step comprises:
initiating a decouple sequence comprising:
activating a decouple button,
determining a communication mode of operation, and
storing in a memory of said first device a minimum data set required to maintain said call wherein said data set corresponds to said communication mode of operation.

20. A module for use with a wireless communication device, comprising:
a connector for attachment to a wireless communication device; and
a memory operable to store a call description associated with an established wireless call in memory and responsive to the detachment of the module during an established wireless call and subsequent attachment of the connector to a wireless communication device to read the call description and subscriber identity information from the memory for transfer to a wireless communication device for use in continuing the call via the wireless communication device.

21. The module as defined in claim 20, further including a detector for detecting connection of the connector to a wireless communication device.

22. The module as defined in claim 20, further including a controller, the controller controlling access to the memory via the connector.

23. A method of operating a module for a wireless communication subscriber device, comprising the steps of:
detecting a detachment event during an established wireless call using a first communication device;
storing a call description associated with the established wireless call in memory; and
reading the call description and subscriber identity information from memory for transfer to a second wireless communication device for use in continuing the call via the second communication device.

24. A method of operating a wireless communication device, the method comprising the steps of:
receiving a call transfer event broadcast from another wireless communication device in a wireless call;
detecting attachment of a subscriber module storing a subscriber identity;
receiving the call description of the wireless call and the subscriber identity to continue the wireless call.

25. A method of operating a wireless communication device comprising
detecting a detachment event during a call;
identifying removal of a subscriber module;
broadcasting a transfer event to other mobile devices;
detecting a request for a call description;
transferring the call description to another requesting device; and
ending participation in the call.
